(19) United States
(12) Patent Application Publication
(10) Pub. No.: US 2005/0243330 A1
(43) Pub. Date: Nov. 3, 2005

(54) Methods and apparatus for determining three dimensional configurations

(76) Inventors: Simon Magarill, Cincinnati, OH (US); William E. Phillips III, Cincinnati, OH (US); Michael Dolgin, Cincinnati, OH (US); Michael W. O'Keefe, Cincinnati, OH (US); David M. Snively, Cincinnati, OH (US)

Correspondence Address: 3M INNOVATIVE PROPERTIES COMPANY, PO BOX 33427, ST. PAUL, MN, 55133-3427, US

(21) Appl. No.: 10/833,624

(22) Filed: Apr. 28, 2004

(51) Int. Cl. G01B 11/24

(52) U.S. Cl. 356/610

(57) ABSTRACT

Three dimensional configurations of a portion of an object (12), such as a patient's tooth, are determined using intensity patterns produced by a projection unit (20) and detected by a sensor unit (22). In some embodiments, the intensity patterns are produced using a set of slides (16A,16B,16C), e.g., a set of photographic slides, while in others they are produced using a transmissive liquid crystal device (60) or a single slide (16) which is moved by a piezoelectric translator (64). Methods and apparatus for reducing the effects of ambient light are also disclosed.

### FIELD OF THE INVENTION

This invention relates to three-dimensional measurement devices. More specifically, it relates to the measurement of 3D shapes based on the application of radiation intensity patterns (e.g., visible and/or near infrared radiation intensity patterns) onto a portion of an object whose three dimensional characteristics are to be determined.

For ease of reference, at various places in the specification and claims, radiation intensity patterns are referred to as “light patterns” or simply as “light,” it being understood that these designations are not intended to, and should not be interpreted as, limiting the scope of the invention to the visible region.

### BACKGROUND OF THE INVENTION

Known methods and devices for 3D shape measurement are described in, for example: U.S. Pat. No. 5,675,407; U.S. Patent Publication No. U.S. 2003/0223083; PCT Patent Publication No. WO 99/34301; and “Color-coded projection grating method for shape measurement with a single exposure,” Applied Optics, 2000, 39:3504-3508.

FIG. 1 is a schematic drawing of an overall configuration of such a device where 20 represents a projection unit, 22 represents a sensor unit, and 12 represents an illuminated object, such as, a patient's tooth. As discussed in the above references, three dimensional configurations can be determined by projecting color-coded gratings onto the surface of object 12, capturing an image of the reflected light using a color sensor unit, and then analyzing the image using a suitable computer program, e.g., a program which employs triangularization of the projection unit, the object, and the sensor.

FIG. 2 shows an example of a color-coded intensity pattern which can be used to determine a three dimensional configuration for a portion of an object using apparatus of the type shown in FIG. 1. As can be seen in this figure, the light pattern essentially is repeatable overlapping of three primary colors (red, green and blue) on the target. The periods of these three primary colors are the same and are displaced relative to each other at ⅓ of a period, where the period for every primary color consists of a linear change of intensity from a minimum intensity, e.g., zero intensity, to a maximum intensity and back to the minimum intensity.

For accurate measurement, the colored light patterns (color channels) employed in the measurement system should work independently, i.e., light from one color channel should not be registered in any other channel. There are two potential ways to exclude such color cross talk:
(1) A projection unit can create images that are separated in spectrum. Color filters in front of individual pixels of, for example, a color CCD camera can then have a matching spectral transmission. However, existing color CCD cameras have very significant levels of cross talk which cause, for example, blue pixels to detect light in the red spectrum and similarly for the other pixels. As a result, existing color CCD cameras are not suitable for accurate 3D measurements. It is probably possible to make a special mosaic filter to address this problem, but to do so would be a complicated and expensive process.
(2) A projection unit can create images that are separated in spectrum and several independent black-and-white CCD cameras can register the resulting signals. In this case, appropriate color filters in front of the cameras and a set of dichroic filters to direct different colored light to the different cameras will eliminate color cross talk. But this solution requires additional space to accommodate several cameras instead of one and the cost of each camera is significant.

As discussed fully below, the present invention, in certain of its embodiments, provides techniques for utilizing a variable intensity light distribution in temporally independent channels to achieve accurate 3D shape measurement. These techniques do not require expensive mosaic color filters or multiple CCD cameras and thus can provide reduced cost solutions to the pattern detection problem. The techniques can also reduce the costs associated with pattern generation. Thus, in certain embodiments, a plurality of slides (e.g., inexpensive photographic slides) can be used to generate the intensity patterns, while in other embodiments, a transmissive pixelized panel or a single slide (e.g., a single photographic slide) which is moved by a piezoelectric device is used for this purpose. Systems employing these approaches can be compact and light weight, allowing for effective implementation in handheld devices.

### SUMMARY OF THE INVENTION

In accordance with a first aspect, the invention provides a method for determining a three-dimensional configuration for a portion of an object comprising:
(A) sequentially illuminating said portion with a series of light patterns, said series comprising N different light patterns, where N is an odd number greater than or equal to three;
(B) detecting light reflected from said portion for each of the N different light patterns; and
(C) determining said three-dimensional configuration using said detected light for the N different light patterns;
wherein the N different light patterns are characterized by:
   (i) a common pattern which is periodic and is phase-shifted among the different patterns by 1/N of a period; and
   (ii) a substantially identical spectral content at said portion of said object;
and wherein in step (A), the series of light patterns is produced using N slides (e.g., N photographic slides), each slide having a periodic transmission function and being separately illuminated to produce one of the N different light patterns, e.g., through the use of a separate light source for each slide, through the use of a common light source for two or more of the slides with separate routing from the source to individual slides, or through a combination thereof.

In accordance with a second aspect, the invention provides a method for determining a three-dimensional configuration for a portion of an object comprising:
(A) sequentially illuminating said portion with a series of light patterns, said series comprising N different light patterns, where N is an odd number greater than or equal to three;
(B) detecting light reflected from said portion for each of the N different light patterns; and
(C) determining said three-dimensional configuration using said detected light for the N different light patterns;
wherein the N different light patterns are characterized by:
   (i) a common pattern which is periodic and is phase-shifted among the different patterns by 1/N of a period; and
   (ii) a substantially identical spectral content at said portion of said object;
and wherein in step (A), the series of light patterns is produced using a light source and a slide which:
(a) has a periodic transmission function, and
(b) is moved to a series of positions to produce the series of light patterns using a piezoelectric device having a cycle time from rest through movement and back to rest which is less than or equal to 3 milliseconds.

In accordance with a third aspect, the invention provides a method for determining a three-dimensional configuration for a portion of an object comprising:
(A) sequentially illuminating said portion with a series of light patterns, said series comprising N different light patterns, where N is an odd number greater than or equal to three;
(B) detecting light reflected from said portion for each of the N different light patterns; and
(C) determining said three-dimensional configuration using said detected light for the N different light patterns;
wherein the N different light patterns are characterized by:
   (i) a common pattern which is periodic and is phase-shifted among the different patterns by 1/N of a period; and
   (ii) a substantially identical spectral content at said portion of said object;
and wherein in step (A), the series of light patterns is produced using a light source and a transmissive pixelized panel (e.g., a liquid crystal display panel) which modulates light from the light source to produce the series of light patterns.

In connection with certain embodiments of this aspect of the invention, the transmissive pixelized panel in addition to producing the series of light patterns, can also produce a light pattern which serves as a pointer for said portion of said object.

In connection with the foregoing aspects of the invention, the substantially identical spectral content can be composed of wavelengths from throughout the visible spectrum, or primarily wavelengths from a selected band of the visible spectrum, e.g., the red band, or primarily wavelengths from the near infrared band of the spectrum.

In certain embodiments of the foregoing aspects of the invention, the light reflected from said portion of said object can be transmitted to a light sensor using a fiber bundle.

In accordance with a fourth aspect, the invention provides a method for determining a three-dimensional configuration for a portion of an object comprising:
(A) sequentially illuminating said portion with a series of light patterns;
(B) detecting light reflected from said portion for each of said light patterns; and
(C) determining said three-dimensional configuration using said detected light patterns;
wherein:
(i) said light patterns have a substantially identical spectral content which is composed primarily of wavelengths from a selected band of the spectrum; and
(ii) said method further comprises filtering ambient illumination to reduce the ambient light intensity within the selected band at said portion of said object.

In certain embodiments of this aspect of the invention, the filtering can be performed using a sheet of filtering material which comprises a first region which transmits the selected band of the spectrum and a second region which substantially blocks the selected band.

In other embodiments, the light reflected from said portion of the object can be detected using a sensor and the light reaching the sensor can be filtered to reduce the intensity of light outside the selected band and thus increase the dynamic range of the signal within the selected band.

In accordance with a fifth aspect, the invention provides an optical system for use in illuminating a portion of an object with N light patterns comprising:
(A) N slides (e.g., N photographic slides) for generating the N light patterns;
(B) a projection lens having an entrance pupil; and
(C) an illumination system for separately passing light through each of the slides and into the projection lens' entrance pupil;
wherein:
(i) the N slides have a common transmission function which is periodic and is phase-shifted among the slides by 1/N of a period; and
(ii) the illumination system and the projection lens sequentially form real images of the N slides which have a substantially identical spectral content.

In accordance with certain embodiments of this aspect of the invention, the illumination system can comprise a prism assembly which separately receives light from each of the N slides and transmits at least a portion of said light to the entrance pupil of the projection lens. In accordance with these embodiments, the prism assembly can receive substantially the same light intensity from each of the N slides and can transmit substantially the same portion of the received light to the projection lens' entrance pupil for each of the N slides.

In accordance with other embodiments of this aspect of the invention, the optical system can be used in combination with a sensor for detecting light reflected from said portion of said object. In connection with these embodiments, a fiber bundle can be used to transmit reflected light to the sensor. Also in connection with these embodiments, the illumination system can produce light having a spectral content which is composed primarily of wavelengths from a selected band of the spectrum and the apparatus can further comprise a first filter for controlling the spectral content of ambient light impinging on said portion of said object and a second filter for controlling the spectral content of reflected light reaching said sensor wherein:
(i) the first filter at least partially blocks light from the selected band of the spectrum; and
(ii) the second filter substantially passes light from the selected band of the spectrum and at least partially blocks light from at least one other band of the spectrum.

In accordance with a sixth aspect, the invention provides an optical system for use in illuminating a portion of an object with first, second, and third light patterns comprising:
(A) first, second, and third slides (e.g., photographic slides) for generating the first, second, and third light patterns, respectively;
(B) a projection lens for forming a real image of each slide, said projection lens having a short conjugate principal plane; and
(C) a prism assembly comprising a first face for receiving light from the first slide, a second face for receiving light from the second slide, a third face for receiving light from the third slide, and a fourth face for transmitting at least some of the light which has entered the prism assembly from the first, second, or third faces to the projection lens;
wherein the optical path length from each slide to the short conjugate principal plane of the projection lens is substantially the same.

In accordance with a seventh aspect, the invention provides an optical system for use in illuminating a portion of an object with first, second, and third light patterns comprising:
(A) first, second, and third slides (e.g., photographic slides) for generating the first, second, and third light patterns, respectively;
(B) a projection lens for forming a real image of each slide; and
(C) a prism assembly comprising a first face for receiving light from the first slide, a second face for receiving light from the second slide, a third face for receiving light from the third slide, and a fourth face for transmitting at least some of the light which has entered the prism assembly from the first, second, or third faces to the projection lens;
wherein:
(i) the mean values of the transmission functions of the three slides are substantially equal; and
(ii) for equal illumination, the prism assembly transmits substantially the same amount of light to the projection lens from each of the slides, e.g., the amount of light transmitted to the projection lens from each of the slides can vary by less than 20 percent and, preferably, by less than 5 percent.

In certain embodiments of this aspect of the invention, the prism assembly can comprise a plurality of subassemblies which define a plurality of diagonals which partially transmit and partially reflect incident light, and the transmission/reflection properties of at least one of said diagonals can differ from the transmission/reflection properties of at least one other of said diagonals.

In accordance with an eighth aspect, the invention provides an optical system for use in illuminating a portion of an object with first, second, and third light patterns comprising:
(A) first, second, and third slides (e.g., photographic slides) for generating the first, second, and third light patterns, respectively;
(B) a projection lens for forming a real image of each slide; and
(C) a prism assembly comprising a first face for receiving light from the first slide, a second face for receiving light from the second slide, a third face for receiving light from the third slide, and a fourth face for transmitting at least some of the light which has entered the prism assembly from the first, second, or third faces to the projection lens;
wherein the first, second, and third faces define first, second, and third planes, the first plane being orthogonal to each of the second and third planes and the second plane being orthogonal to the third plane.

In certain embodiments of this aspect of the invention, first, second, and third light sources can be associated with the first, second, and third slides, respectively, and the optical paths from the first light source to the first slide and from the second light source to the second slide can be straight and the optical path from the third light source to the third slide can be folded, e.g., the path can be folded by a prism.

In accordance with a ninth aspect, the invention provides an optical system for use in illuminating a portion of an object with first, second, and third light patterns comprising:
(A) first, second, and third slides (e.g., photographic slides) for generating the first, second, and third light patterns, respectively;
(B) a projection lens for forming a real image of each slide; and
(C) a prism assembly comprising a first face for receiving light from the first slide, a second face for receiving light from the second slide, a third face for receiving light from the third slide, and a fourth face for transmitting at least some of the light which has entered the prism assembly from the first, second, or third faces to the projection lens;
wherein:
(i) the optical system further comprises a light source which can be selectively activated;
(ii) the prism assembly comprises a fifth face for receiving light from the light source; and
(iii) the fourth face transmits at least some of the light which has entered the prism assembly through the fifth face to the projection lens.

In accordance with a tenth aspect, the invention provides apparatus for use in determining a three-dimensional configuration for a portion of an object comprising:
(A) an optical system for illuminating said portion of said object with a plurality of light patterns;
(B) a sensor assembly for detecting light reflected from said portion, said assembly comprising first and second sensors (e.g., a color CCD sensor and a black and white CCD sensor); and
(C) a fiber bundle for transmitting reflected light to said sensor assembly;
wherein the sensor assembly comprises a router for providing reflected light to the first and second sensors.

In certain embodiments of this aspect of the invention, the router can comprise a stationary mirror which transmits substantially equal portions of the reflected light to the first and second sensors. In other embodiments, the router can comprise a movable mirror for selectively providing reflected light to the first and second sensors.

In accordance with an eleventh aspect, the invention provides apparatus for use in determining a three-dimensional configuration for a portion of an object comprising:
(A) an optical system for illuminating said portion of said object with a plurality of light patterns, said light patterns being composed primarily of wavelengths from a selected band of the spectrum (e.g., the red band); and
(B) a sheet of filtering material which comprises a first region which transmits the selected band of the spectrum and a second region which substantially blocks the selected band.

In addition to the above-listed individual aspects, the invention also comprises any and all combinations of these aspects.

It is to be understood that both the foregoing general description and the following detailed description are merely exemplary of the invention, and are intended to provide an overview or framework for understanding the nature and character of the invention.

Additional features and advantages of the invention are set forth in the detailed description which follows, and in part will be readily apparent to those skilled in the art from that description or recognized by practicing the invention as described herein. The accompanying drawings are included to provide a further understanding of the invention, and are incorporated in and constitute a part of this specification. As with the written description, these drawings are explanatory only and should not be considered as restrictive of the invention.

### BRIEF DESCRIPTION OF THE DRAWINGS

FIG. 1 is a schematic drawing showing an overall arrangement of a projection unit, an object, and a sensor unit.

FIG. 2 is a plot of a light pattern which can be used in determining three dimensional configurations. In particular, the figure shows normalized intensity (vertical axis) versus a linear coordinate across a target plane or target object (horizontal axis).

FIG. 3 is a schematic drawing of an optical system which can be used to produce a desired light pattern on an object.

FIG. 4 is a schematic drawing showing an optical layout for an embodiment of the invention which employs three slides.

FIG. 5 is an exploded, perspective view showing a spatial arrangement for the optical components of FIG. 4.

FIG. 6 is a perspective view showing a spatial arrangement for another embodiment of the invention which employs three slides.

FIGS. 7A and 7B are schematic drawings of an optical layout for an embodiment of the invention suitable for packaging in a handheld device. FIG. 7A is a top view and FIG. 7B is a side view.

FIG. 8 is a perspective view of an illuminator which can be used in the optical layout of FIGS. 7A and 7B.

FIG. 9 is a schematic drawing of a sensor lens assembly which can be used in the optical layout of FIGS. 7A and 7B.

FIG. 10 is a schematic drawing of a projection lens assembly which can be used in the optical layout of FIGS. 7A and 7B.

FIGS. 11a, 11b, and 11c illustrate transmission functions of three photographic slides which can be used to produce desired light patterns on an object whose three dimensional configuration is to be determined.

FIG. 12 is a schematic drawing illustrating filtering of ambient light reaching an object which is to be measured, as well as filtering of reflected light reaching a sensor from the object.

FIG. 13 is a schematic drawing showing an optical layout for an embodiment of the invention which employs a fiber bundle.

FIG. 14 is a schematic drawing showing an optical layout for a further embodiment of the invention which employs three slides.

FIG. 15 is a schematic drawing showing an optical layout for an embodiment of the invention which employs a transmissive pixelized panel.

FIG. 16 is a plot of relative intensity versus pixel number for a triangular intensity pattern produced by a transmissive pixelized panel having a 100:1 contrast ratio.

FIG. 17 is a schematic drawing showing an optical layout for an embodiment of the invention which employs a single slide and a piezoelectric device (piezoelectric translator).

FIG. 18 is a schematic drawing illustrating movement of the slide of FIG. 17 relative to a light stop.

FIG. 19 shows three intensity patterns produced by movement of the slide of FIG. 17.

FIG. 20 is a plot showing a cycle pattern which can be used with the embodiment of FIG. 17.

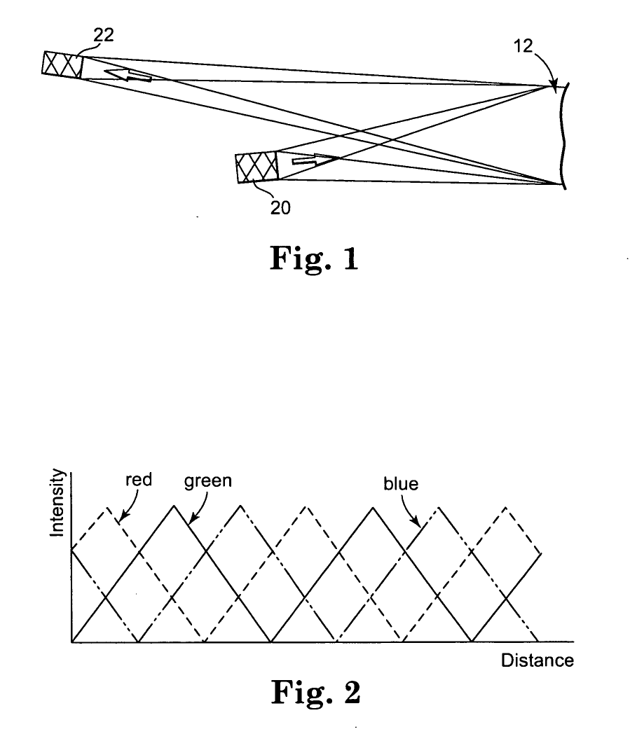

The reference numbers used in the drawings generally correspond to the following:
1 first plane/first face of prism assembly
2 second plane/second face of prism assembly
3 third plane/third face of prism assembly
4 fourth face of prism assembly
5 fifth face of prism assembly
12 target plane/illuminated object, e.g., a patient's tooth
14 illuminator
16 slide
16A slide A
16B slide B
16C slide C
18 projection lens
20 projection unit
22 sensor unit
24 prism assembly
26A light source A, e.g., a red LED
26B light source B, e.g., a red LED
26C light source C, e.g., a red LED
28 condenser
30 prism
32 Fresnel lens
34 sheet of filtering material
34A first region of sheet 34 which transmits a selected band of the spectrum
34B second region of sheet 34 which substantially blocks the selected band of the spectrum
38 sensor filter
40 pointer
42 CCD sensor
44 CCD lens
46 mirror
48 lens
50 fiber bundle
52 lens
54 mirror
56 black and white sensor, e.g., black and white CCD
58 color sensor, e.g., color CCD
60 transmissive pixelized panel
62 light stop
64 translator
66 patient mouth area

### DESCRIPTION OF THE PREFERRED EMBODIMENTS

As discussed above, in certain embodiments, the 3D measuring systems of the invention use three (or more) sets of measured reflected intensities to determine a three-dimensional configuration for a portion of an object. The three-dimensional configuration can be determined from the measured reflected intensity patterns using computer programs known in the art for analyzing such patterns. See, for example, the triangularization techniques discussed in the above-referenced U.S. Patent Publication No. US 2003/0223083.

The intensity patterns used in determining three dimensional configurations can have substantially identical mean intensities at the portion of the object which is being measured. In this way, the patterns as detected can be used directly in the configuration determination process without the need for adjustments in the recorded data to take account of mean intensity variations. For purposes of the present invention, two light patterns are considered to have substantially identical mean intensity values at a portion of an object if those values are within 20 percent of each other, preferably within 10 percent, and most preferably within 5 percent.

The intensity patterns can also have substantially identical spectral contents at the portion of the object which is being measured. Again, this facilities direct use of the detected intensities in determining three dimensional configurations, without the need to adjust those intensities based on different response characteristics of a sensor to different wavelengths (e.g., the different response characteristics to different wavelengths exhibited by CCD cameras). As known in the art, the spectral content of an intensity pattern can be determined using a spectral analyzer. For purposes of the present invention, two intensity patterns are considered to have substantially identical spectral contents at a portion of an object if 80 percent or more of the energy of the two patterns lies in a common wavelength range whose width is less than or equal to 160 nanometers, e.g., 80 percent or more of the energy of the two patterns lies in the red band of the visible spectrum which extends from 580 nanometers to 690 nanometers and thus has a width of 110 nanometers.

As indicated above, the intensity patterns used in the practice of the invention need not be in the visible range. Rather, any wavelength range that can be projected onto an object and detected by a sensor after reflection can be used. For example, the patterns can include some spectral components in the near infrared range and, indeed, can have essentially all of their intensity in that range.

When intensity patterns having substantially identical spectral contents are used, the configuration information regarding the object is obtained by sequential illumination of the object and not by color. That is, at every given time, the signal registered by the sensor is coming from one channel only.

For these embodiments, individual sources can be used for the individual channels (i.e., one source per channel), with the sources being operated sequentially. The sources can, for example, be of the type which can be switched on and off rapidly, e.g., the sources can be light emitting diodes (LEDs). LEDs have a small footprint which makes for an overall compact device, which is advantageous when a handheld system is desired (e.g., a system to be used to determine the configuration of, for example, a patient's tooth). Alternatively, a single source can be used whose output is switched (routed) between the different channels. One or more LEDs can again be used as the source for this approach.

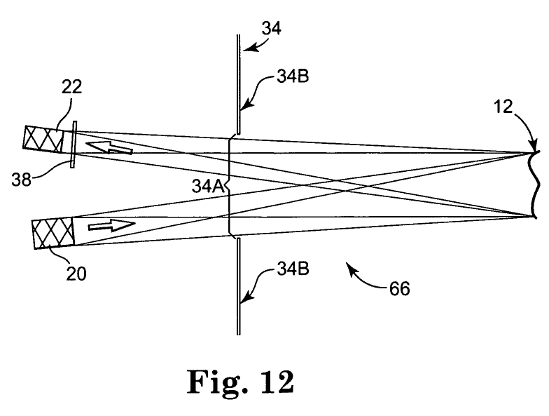

In terms of selecting LEDs for use in practicing the invention, red LEDs have the advantages of being widely available and the red spectrum of such devices matches the higher sensitivity region of a CCD camera. Also, a red filter (a low cost component) can be placed in front of the CCD camera (see filter 38 in FIG. 12), making the camera substantially insensitive to any light except red. In this way, the camera can be protected from ambient light, specifically, from other than red ambient light, which reduces noise and increases the accuracy of the detection process and thus the determination of three dimensional configurations. One or more red LED's can thus effectively serve as the source of the intensity patterns projected onto the object to be measured.

In accordance with the invention, the required intensity distributions on the surface of the object to be measured can be produced using a set of slides, e.g., a set of three slides. The slides can be photographic slides (e.g., black and white photographic slides). Such slides have the advantage of low cost. The slides can also be formed by varying the density of a deposited metal, e.g., chromium, on a substrate, e.g., a glass substrate. Photographic slides can be used for systems operating in the visible region of the spectrum, as well as those operating partially or entirely in the near infrared region. Slides formed by depositing a metal on a substrate can also be used in the visible and/or near infrared regions of the spectrum.

When photographic slides are used, they can be prepared in accordance with the procedures of U.S. application Ser. No. ______ entitled “Photographic Slides Having Specified Transmission Functions”, Docket No. 59636US002, which is being filed simultaneously herewith. The contents of this co-pending application are incorporated herein by reference.

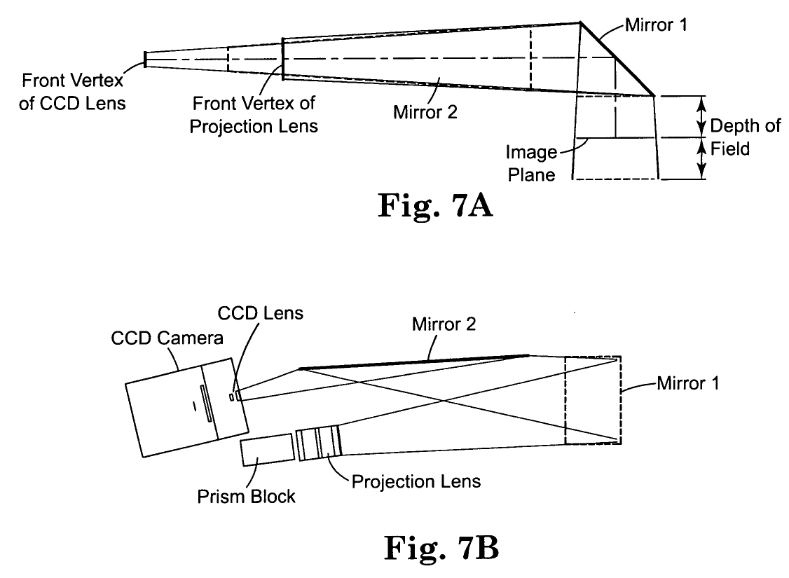

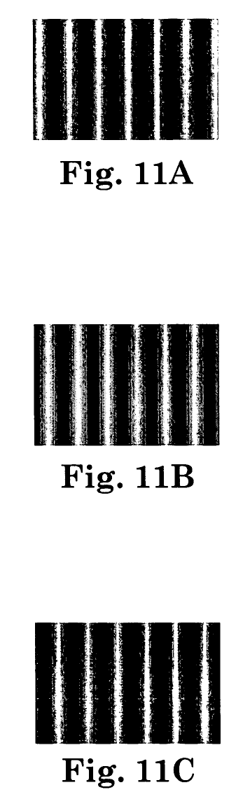

FIG. 11 of the present application, which corresponds to FIG. 7 of the above-referenced, co-pending application, illustrates a set of three photographic slides which can be used in the practice of the present invention, where each slide has a periodic transmission function having the same period and structure (e.g., triangular within each period in this case), with the transmission functions of the three slides being shifted relative to one another by one third of a period. The transmission functions of these slides can be linear to within 3 percent (preferably, to within 2 percent) for at least 85 percent of each period (preferably, for at least 90 percent of each period). Such linearity facilitates the accurate determination of three dimensional configurations.

When slides of the type shown in FIG. 11 are sequentially illuminated so as to produce intensity patterns have substantially identical spectral contents, the result is a set of patterns like that shown in FIG. 2, but with the patterns being formed on the object sequentially, rather than simultaneously as in FIG. 2, and with the patterns having substantially identical spectral contents, rather than distinguishable red, green, and blue contents as in FIG. 2.

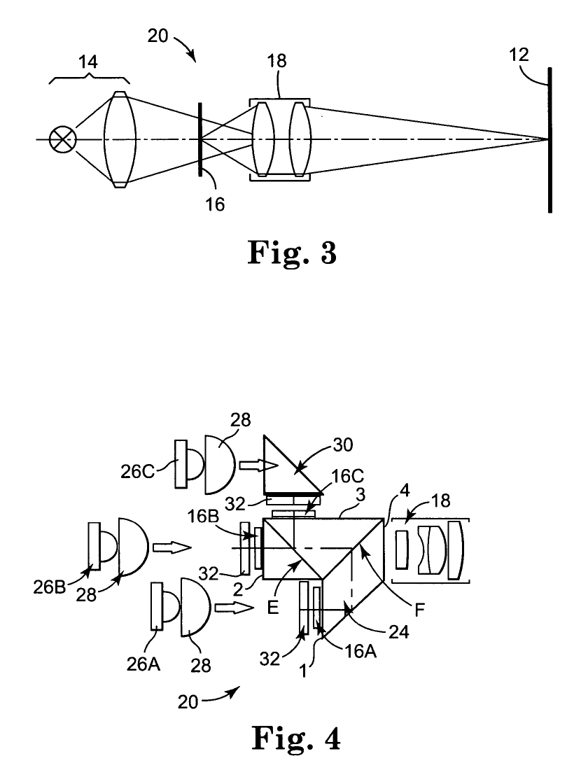

An optical layout which can be used to produce an intensity pattern on a portion of an object whose three dimensional configuration is to be determined is shown in FIG. 3. As shown therein, optical system 20 can comprise an illuminator 14, a slide 16 (e.g., a photographic slide), and a projection lens assembly 18 containing one or more lens elements organized into one or more lens units. Illuminator 14 can comprise one or more light sources and suitable optics for forming images of the light sources in the entrance pupil of the projection lens. The spacing between slide 16 and projection lens 18 can be selected so that the lens forms an image of the slide on target plane (target object) 12.

FIG. 3 shows one channel of, for example, a three channel system for illuminating a target object. FIGS. 4-10 show the structure of representative three channel systems which can be used in the practice of the invention.

In particular, FIG. 4 shows three identical light sources (e.g., three commercially available LEDs 26A, 26B, and 26C, each of which is coupled with a condenser lens 28) illuminating three slides 16A, 16B, and 16C, which can, for example, be the slides of FIGS. 11A, 11B, and 11C. As shown in this figure, a Fresnel lens 32 can be placed in front of each slide. Such a lens serves to collect light into the entrance pupil of projection lens 18 from the LED/condenser combination. To provide compactness, one or more prisms can be used to bend one or more of the illumination paths. For example, FIG. 4 shows the use of prism 30 between LED 26C and slide 16C.

Prism assembly 24 delivers light from the three slides into projection lens 18. It thus serves as a light combiner. The assembly can be sized and arranged so that the optical path length from each slide to the short conjugate principal plane of the projection lens is substantially the same, e.g., the difference in optical path lengths for the different channels can be less than or equal to 0.1 mm and preferably, less than or equal to 0.05 mm.

The prism assembly can be designed so that for equal illumination, it transmits substantially the same amount of light to the projection lens from each of the slides. To that end, the transmission/reflection properties of at least one of the diagonals of the prism assembly can differ from the transmission/reflection properties of at least one other of the diagonals. As an example, for light in the red spectral range, diagonal E in FIG. 4 can be a 50% reflector and diagonal F can have 33% reflection and 66% transmission. This provides substantially equal intensity of the light for all three channels as follows:
(A) Light from slide 16A reflects from diagonal F with intensity 0.33.
(B) Light from slide 16B transmits through diagonals E and F with intensity 0.66×0.5=0.33.
(C) Light from slide 16C reflects from diagonal E and transmits through diagonal F with intensity 0.66×0.5=0.33.

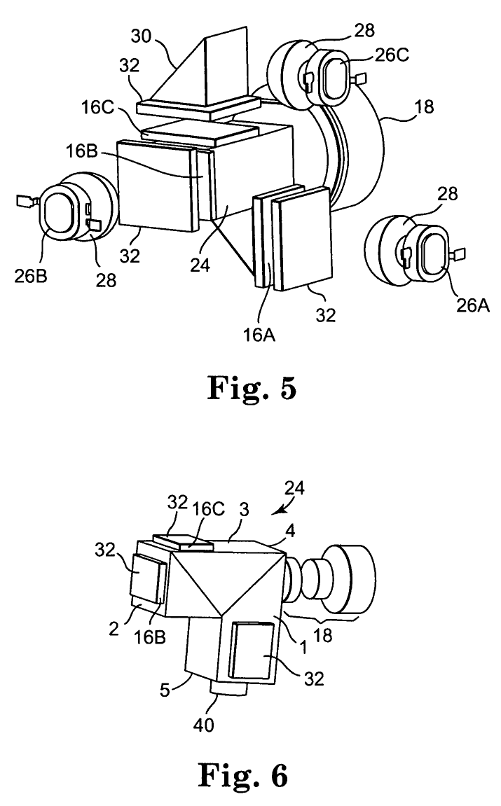

The prism assembly of FIG. 4 can be spatially arranged as shown in FIG. 5 to reduce the footprint of the device. As can be seen in this figure, the faces of the prism assembly which receive light from slides 16A, 16B, and 16C are oriented so that they lie in planes that are orthogonal to one another. This arrangement is also illustrated in FIG. 6 where the faces of the prism assembly which receive light from slides 16A, 16B, and 16C are identified by reference numbers 1, 2, and 3, and the face which delivers light to projection lens 18 is identified by the reference number 4. As can be seen in this figure, faces 1, 2, and 3 define planes which intersect one another at right angles.

For comparison, FIG. 14 shows an embodiment in which faces 1, 2, and 3 do not lie in orthogonal planes. Specifically, the plane of face 1 in this figure, although perpendicular to the plane of face 3, is parallel, rather than perpendicular, to the plane of face 2. Because of this arrangement, for the same components mounted in the same way, the overall volume of the prism assembly and its associated light sources will be larger for the embodiment of FIG. 14 than for the embodiment of FIGS. 5 and 6. Other than for this difference, the performance of the embodiment of FIG. 14 can be the same as that of FIGS. 5 and 6.

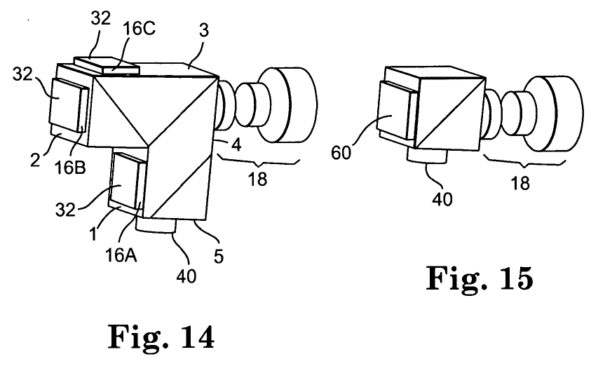

In addition to illustrating an orientation for the faces of the prism assembly which achieves a small footprint, FIG. 6 also illustrates the incorporation of a pointer 40 into the system, which can serve as an aid in positioning the imaging device relative to an object whose three dimensional configuration is to be determined (e.g., a patient's tooth). Pointer 40 can, for example, be a fourth LED which can be activated separately from LEDs 26A, 26B, and 26C prior to the commencement of the determination of a three-dimensional configuration. Pointer 40 is also illustrated in the embodiment of FIG. 14, discussed above, and that of FIG. 15 discussed below.

FIGS. 7-10 illustrate an embodiment of the invention suitable for use as an intraoral camera to take 3D pictures of one or more teeth of a patient in a dental office setting. The 3D pictures can subsequently be used to create, for example, a solid model which can be used in diagnosis and/or the preparation of braces, crowns, etc. The apparatus of these figures can be used with the photographic slides of FIG. 11 or other intensity pattern generators, as desired.

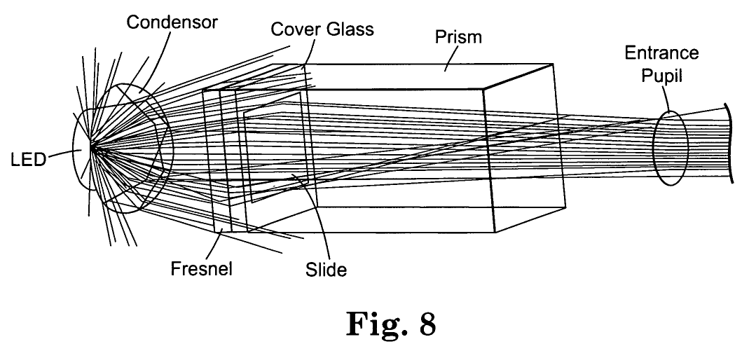

As shown in FIG. 7, the 3D camera can comprise a projection path and a sensor path. The projection path can comprise three LED illuminators, a prism assembly (prism block) with attached slides (e.g., photographic slides of the type illustrated in FIG. 11), a pointer, and a projection lens. As shown in FIG. 8, each of the three LED illuminators can comprise an LED, a condenser lens, and a Fresnel lens. A suitable prescription for such an illuminator is set forth in Table 1, where all dimensions are in millimeters.

The prism assembly can, for example, comprise a plurality of subassemblies, e.g., six right-angle prisms which, for example, can have edge lengths of 10 mm. As another alternative, two pairs of the right angle prisms can be combined, with the final prism assembly comprising two right-angle prisms and two prisms of more complex shape (see, for example, the prisms illustrated in FIG. 6). The subassemblies making up the prism assembly can be cemented together using an optical adhesive.

As illustrated in FIG. 8, the slides can be supported on a cover glass. In the case of photographic slides, the slides can be cemented to the cover glass using an optical cement with the emulsion side of the slide towards the glass. The slide/cover glass assembly can then be brought into contact with the prism assembly and aligned. The use of a cover glass allows mechanical contact to be maintained between the slide and the prism assembly without the need for optical cement.

The slides can be prepared using the techniques of the above-referenced U.S. application Ser. No. ______ entitled “Photographic Slides Having Specified Transmission Functions”, Docket No. 59636US002 A suitable film is KODAK Elite Chrome film. Each slide can comprise twelve cycles of intensity variation, with a phase shift of 120 degrees between the three slides. The image size of the exposed area on each slide can be 8.325 mm×6.25 mm.

As shown in FIG. 8, the Fresnel lens can be located directly behind each slide's cover glass. The Fresnel lens can have its smooth surface toward the cover glass and can be maintained in mechanical contact with the cover glass without the use of optical cement.

The system's pointer 40 can comprise a pinhole (e.g., a pinhole having a 0.02-0.04 mm diameter) with a separately operable red LED mechanically mounted behind it. The surface of the prism assembly which receives light from the pointer (e.g., the face identified by the reference number 5 in FIG. 6) can be a ground surface.

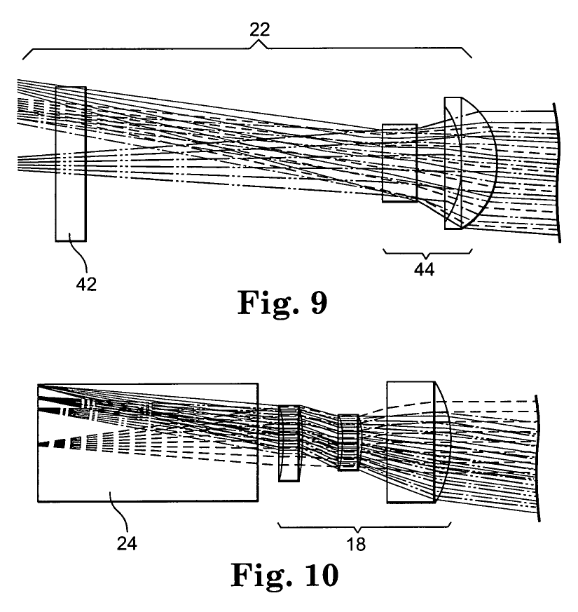

As shown in FIG. 9, the sensor path can include a sensor unit 22 which comprises, for example, a CCD sensor 42 (e.g., a SONY, model XC-HP50, monochrome camera having a 4.9 mm×3.8 mm CCD array) and a CCD lens 44. Tables 2 and 3 set forth a suitable prescription for the CCD lens where the dimensions of Table 2 are in millimeters and the conic constant k and aspheric coefficients D through G of Table 3 are for use in the following equation:

$$z = \frac{{cy}^{2}}{1 + {[ 1 - ( 1 + k ) {c}^{2} {y}^{2} ]}^{1 / 2}} + {Dy}^{4} + {Ey}^{6} + {Fy}^{8} + {Gy}^{10} + {Hy}^{12} + {Iy}^{14} \qquad ( 1 )$$

where z is the surface sag at a distance y from the optical axis of the system and c is the curvature of the surface at the optical axis. The prescriptions of Tables 2 and 3 assume that the system employs red LEDs operating in the 630-670 nm range.

FIG. 10 shows a projection lens 18 which can be used in this embodiment of the invention and Tables 4 and 5 set forth a suitable prescription for this lens. As in Tables 2 and 3, the dimensions of Table 4 are in millimeters and the aspheric coefficients and conic constants of Table 5 are for use in equation (1) above. This prescription again assumes that the system employs red LEDs operating in the 630-670 nm range. The projection lens of Tables 4 and 5 has a short conjugate principal plane and an entrance pupil whose distances from surface 1 of Table 4 are +24.26 millimeters and +11.4 millimeters, respectively, where positive distances are to the right in FIG. 10.

Turning now to FIG. 12, this figure illustrates another aspect of the invention directed to the problem of ambient light. As discussed above, one application of the invention is in connection with determining three dimensional configurations of teeth in dental offices. Dentists and their assistants cannot work in the dark, which creates the problem of reduced signal-to-noise ratio as a result of ambient light being reflected from the object being measured and captured by the sensor. This problem is not unique to dental applications, but can also exist for other applications of the invention where observation of an object being measured is needed or desired.

FIG. 12 illustrates a system which allows a user, e.g., a dentist, to have a clear view of an object being measured, e.g., a clear view of a tooth inside a patient's mouth area 66, while reducing the amount of ambient light which can reflect from the object and reach the sensor. As shown in this figure, a sheet of filtering material 34 is used to block ambient light. The sheet can include a first region 34A which transmits a selected band of the spectrum, e.g., red light, and a second region 34B which substantially blocks that band. Second region 34B can significantly reduce the amount of ambient light within the band which reaches the object being measured and thus can improve the performance of a camera system which uses that band to determine three dimensional configurations. As also shown in this figure, a filter 38 which substantially passes the selected band and substantially blocks at least some light outside of the band can be placed in front of sensor unit 22.

As one example, a disposable, red reflective filter can be used to cover a patient's mouth and can include an aperture (first region 34A) which allows projection unit 20 to project light onto a patient's tooth and sensor unit 22 to receive reflected light from the tooth. Although not specifically shown in FIG. 12, the aperture can contact a housing for the projection unit and/or the sensor unit. With the filter in place, the ambient light on the measured tooth surface will have blue and green components (with little red), which will be visible to the dentist but essentially invisible to the sensor unit, especially, when a sensor filter 38 is used which substantially transmits red light, e.g., red light from red LEDs, and substantially reflects other colors.

Examples of materials which can be used for region 34B of filter 34 include various plastics, e.g., acrylic plastics, which contain one or more pigments which absorb light in the selected band. As just one example, the pigment pthalocyanine can be used to produce a moldable acrylic which has a transmission of about 90 percent in the green band but only about 30 percent in the red band. Such a material is commercially available under the designation V825-38205, part number 30338, from LTL Color Compounders, Inc., Morrisville, Pa. 19067. As discussed above, region 34A of filter 34 can be an aperture. Alternatively, region 34A can be composed of a material which can transmit the selected band of the spectrum, e.g., a material which can transmit red light. As just one example, acrylic plastics which are transparent in the visible range can be used to form region 34A. Sensor filter 38 will typically be a dichroic filter which preferentially transmits the selected band and blocks light outside of that band. Commercially-available dichroic filters will generally be used, although custom filters can be used if desired. As will be recognized by those skilled in the art, materials other than those mentioned above, now known or subsequently developed, can be used in the practice of this aspect of the invention.

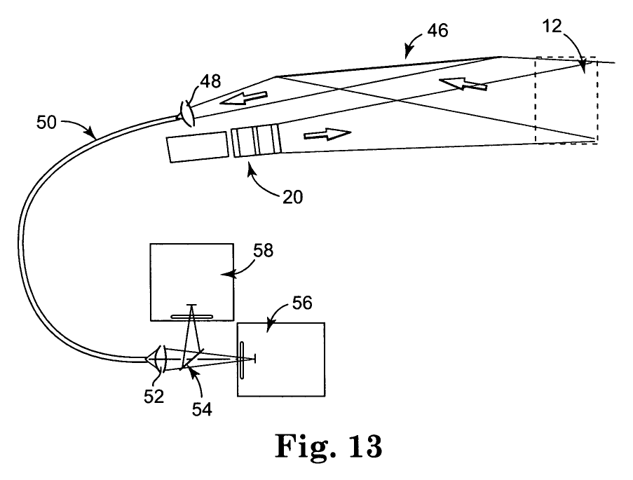

FIG. 13 illustrates an embodiment of the invention which can facilitate handheld operation. As illustrated in this figure, projection and sensor portions of an overall system are located in separate units and connected by a fiber bundle 50. This separation can facilitate handheld operation since only the projection portion needs have a size and configuration suitable for hand manipulation.

Separating the projection and sensor portions of the overall system can also allow for increased functionality. For example, accurate 3D image creation is facilitated through the use of a black and white sensor, e.g., a black and white CCD camera. However, for many applications, including dental applications, color 2D imaging is also desired and this requires a color sensor, e.g., a color CCD camera. Handheld devices have limited available space which typically is insufficient to accommodate two sensors. By separating the projection unit from the sensor unit, two sensors, e.g., a color CCD camera and a black and white CCD camera, can be located in, for example, a tabletop unit where space restrictions are much less. Also, all electronics for sensor operation can be located closer to the sensor to reduce the noise level of the registered signal.

As shown in FIG. 13, fiber bundle 50 can be located between lenses 48 and 52. The overall light path then proceeds from projection unit 20, to object 12, to mirror 46, and then to lens 48. This lens creates an image of the object intensity distribution on the flat end of the fiber bundle. Lens 52 receives exiting light from the fiber bundle and images that light onto a sensor unit, e.g., a CCD array. Lens 48 and/or lens 52 can comprise one or more lens elements as desired.

As shown in FIG. 13, the light exiting from lens 52 can be routed to multiple sensor units, e.g., a black and white sensor 56 and a color sensor 58. The routing can, for example, be done using a stationary mirror 54, e.g., a 50% mirror which splits the light into two light beams having substantially identical light intensities. One beam can form an image of the fiber exit end on the black & white sensor the other beam can form a corresponding image on the color sensor. Both sensors can work at the same time.

As another alternative, a movable mirror can be used. For example, the mirror can be in the optical path only for 2D color imaging and can be removed from the light path for 3D imaging. Linear or rotational motion of the mirror, or a combination of such motions, can be used for such sequential operation.

To reduce noise associated with ambient light, a sensor filter, e.g., a red transmissive filter for a 3D system which uses red LEDs, can be placed ahead of the black and white sensor. Such a filter will generally not be used ahead of the color sensor when a full color image is desired. Also, the use of a layer of filter material to control the spectral content of ambient light reaching the object (see FIG. 12) may interfere with the ability to obtain a full color image from the color sensor. Accordingly, such a filter layer may be temporarily removed when a full color image is desired or the projection unit can be equipped with a broad spectrum light source whose light can reach the object being examined when full color imaging is desired, e.g., a broad spectrum light source whose light can reach the object by, for example, passing through region 34A of filter material 34 in FIG. 12.

Fiber bundle 50 should provide enough resolution to maintain required image quality at the sensor, e.g., at a CCD camera. One example of a fiber bundle having sufficient resolution is a fiber bundle from Schott North America Inc., part number IG-163. This bundle has an imaging area of 8 mm×10 mm, and the diameter of the individual elements making up the bundle is 10 micrometers. The active area of a typical camera CCD array is 3.8 mm×4.8 mm which means that to image the exit end of the above bundle onto such a CCD array, the magnification of lens 52 in FIG. 13 should be −0.48×. In this case, the size of the image of the fiber element on the CCD array will be 4.8 micrometers, which is almost half of the pixel size of the CCD array (7.6 micrometers). Accordingly, a fiber bundle of this type can extract an image from a handheld device without diminishing image quality.

Handheld devices which are compact can be of particular value in the case of a camera intended for use in determining three dimensional configurations of a patient's tooth. However, the use of a fiber bundle to separate the projection and sensor portions of an overall system is not limited to such applications and, indeed, the approach can be employed in applications in which no part of the system is intended to be handheld during use.

FIG. 15 illustrates an embodiment of the invention which employs a transmissive pixelized panel 60, specifically, a transmissive liquid crystal display (LCD) panel, to generate the intensity distributions which are used to determine three dimensional configurations. As can be seen in this figure, only a single optical channel is needed for this embodiment, as opposed to the three optical channels used in the slide-based embodiments discussed above (see, for example, FIG. 14).

As can also be seen in FIG. 15, a simpler post-panel prism assembly can be used with the transmissive pixelized panel approach than that used with the slide approach (again, see, for example, FIG. 14). Indeed, if desired, the prism assembly and pointer 40 shown in FIG. 15 can be eliminated by using the transmissive pixelized panel to perform the pointing function, e.g., by controlling the transmissive state of the pixels of the panel so that light can only pass through the central portion of the panel.

Although not shown in FIG. 15, an LED, e.g., a red LED, and a condenser lens can be used as a backlight to illuminate the input side of the LCD, with light passing directly from the backlight to the LCD without an intervening prism assembly. It should be noted that reflective pixelized panels, e.g., digital light panels (DLPs) and reflective liquid crystal devices (LCoSs), require complex prism assemblies ahead of the device to route input and output light. Transmissive pixelized panels do not need such prisms which make such panels particularly well-suited for use in 3D cameras, including 3D cameras where all or part of the camera is handheld.

In addition to eliminating the need for complex prisms, a transmissive pixelized panel which operates through a single optical channel can result in a smaller package for the camera, a reduced component count, and easier assembly since fewer components need to be aligned. Also, compared to the slide approach, different intensity distribution patterns (e.g., patterns having more or less cycles across the portion of the object being measured) can be readily programmed into the system without the need to change components.

Improved light utilization can also be achieved. Thus, for a typical LCD and a prism which has a 95/5 split between the panel and a pointer, the throughput from the panel to the projection lens can be about 20%. This throughput includes the loss of light which occurs as light passes through the polarizer and analyzer components arranged on the input and output sides of the LCD's layer of liquid crystal material. For comparison, for a system using three photographic slides, each slide receives about 30% of the total input light. When combined with the transmission of the film, this results in an overall throughput of about 12%. The difference becomes even greater when the pixelized panel is used to perform pointing and the prism used to route light from a pointer to the projection lens is removed.

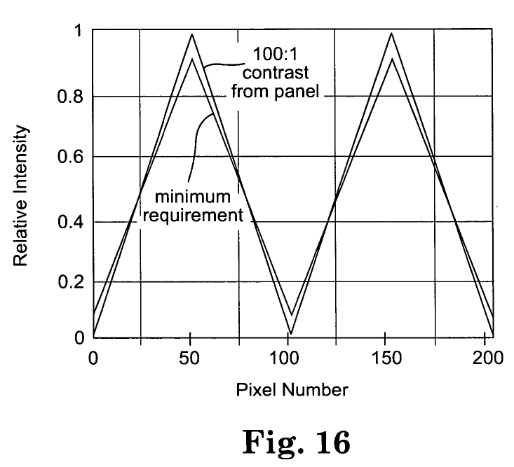

In operation, the intensity patterns are generated by temporally changing the transmission of the pixelized panel, e.g., by phase shifting a triangular pattern by 0, 120, and 240 degrees. Suitable signal to noise ratios for three dimensional imaging can be achieved using an XGA panel having a 100:1 contrast ratio. FIG. 16 illustrates the performance of such a panel for the first two cycles of a 10 cycle triangular intensity pattern (see the curve marked “100:1 contrast from panel”). As a general guideline, for 3D image capture using a triangular waveform, the waveform should comprise a least 83% of the total signal captured (see the curve marked “minimum requirement” in FIG. 16). As can be seen in FIG. 16, a transmissive pixelized panel with a 100:1 contrast ratio meets this guideline. Commercially available LCDs generally have contrast ratios of at least 100:1.

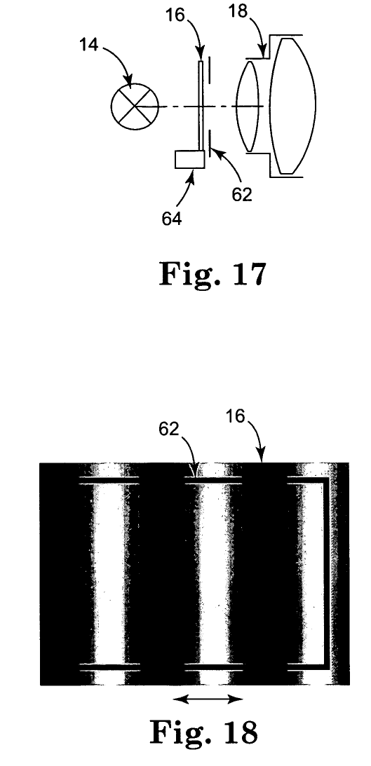

FIGS. 17-20 illustrate another embodiment of the invention which uses a single slide and a piezoelectric translator. As illustrated in FIG. 17, for this embodiment, the projection unit of the 3D camera can be arranged as an illuminator 14, a slide 16 with a selected transmission function (e.g., a periodic triangular transmission function), a piezoelectric translator 64 for moving the slide, and a projection lens 18 for forming an image of the slide on the portion of the object whose three dimensional configuration is to be determined. Light stop 62 is located next to slide 16 and determines the area of the slide that is projected forward through the projection lens (see FIG. 18).

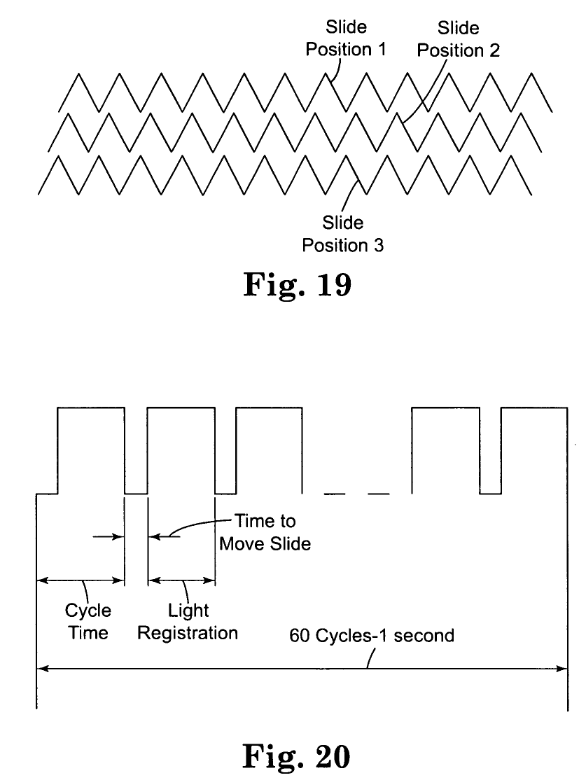

In operation, the translator moves the slide in the lateral direction to expose different areas of the slide at different times. As illustrated in FIG. 19, the result is phase-shifted intensity patterns at the object.

In order to produce accurate 3D images, the piezoelectric translator has to both accurately position the slide and move the slide quickly enough so that it is in position when the next recording of light reflected from the object takes place. For example, for a slide with a lateral dimension of 8.325 mm and a transmission function with 12 cycles, the distance between two positions of the slide for a 120 degree phase shift is 0.23 mm. For one percent accuracy, a piezoelectric translator which can position the slide to within about 2 micrometers can be used.

FIG. 20 illustrates a representative temporal cycle for a 3D camera. As can be seen in this figure, the overall cycle time includes: (1) a light registration time, which for a typical CCD camera includes a light detection portion and a pixel reading/camera reset portion (not shown in FIG. 20), and (2) time to move the slide. Although shown as separate times in FIG. 20, the time to move the slide can overlap with the pixel reading/camera reset portion of the light registration time. However, in general, the time to move the slide should not overlap with the light detection portion of the light registration time since movement of the slide during this portion can degrade the quality of the image.

The overall cycle time is preferably short enough to avoid substantial camera movement between the recording of multiple phase-shifted intensity patterns. This is especially important in connection with handheld 3D cameras, such as those used to produce three dimensional images of a patient's tooth. Excessive movement can significantly degrade the quality of the reconstructed three dimensional image.

In practice, it has been found that three images can be taken without significant movement artifacts if the overall cycle time for each image is 1/60 of a second (16.7 milliseconds). For an 80:20 split between the light registration time and the time to move the slide, this corresponds to a cycle time of approximately 3 milliseconds for the slide to transition from rest through movement and back to rest between images. If more than three phase-shifted intensity patterns are used, e.g., five patterns, the overall cycle time is shorter, e.g., on the order of 10 milliseconds, thus reducing the time to move the slide to about 2 milliseconds for an 80:20 split between movement and image capture. Accordingly, the piezoelectric actuator when moving the slide preferably has a cycle time from rest through movement and back to rest which is less than or equal to 3 milliseconds and, more preferably, less than or equal to 2 milliseconds.

The slide and any support structures used to hold the slide, e.g., a cover glass, should have a low enough mass to be accurately and quickly moved by the piezoelectric actuator. For example, the mass of the slide and its support structures can be less than or equal to 2 grams and, preferably, can be less than or equal to 0.5 grams.

Piezoelectric devices are commercially available which have a high degree of positional accuracy, a short cycle time, and are able to move a mass of 2 grams. As just one example, the HVPZT Disk Translator model P-288.00, manufactured by PI (Physic Instrumente) L.P., has a resonant frequency of 2 kHz, which corresponds to a minimal response time of 5 ten thousands of the second, which is about six times shorter than the required cycle time. This device provides positional accuracy at the micrometer level and can develop a force of 5 N (510 gm force). Other piezoelectric devices, now known or subsequently developed, can, of course, be used in the practice of these aspects of the invention if desired.

Although specific embodiments of the invention have been described and illustrated, it is to be understood that a variety of modifications which do not depart from the scope and spirit of the invention will be evident to persons of ordinary skill in the art from the foregoing disclosure.

TABLE 1

| ## | R | T | material | CA |
|---|---|---|---|---|
| LED lens | ∞ | 2.8 | COC | 5.6 |
| | −2.8 | 0 | | 5.6 |
| Condenser | −22.0 | 3.5 | SF2 | 8.0 |
| | −4.8 | 6.0 | | 9.0 |
| Fresnel | ∞ | 1.5 | ACRYLIC | 10.0 × 10.0 |
| | ∞ | | | 10.0 × 10.0 |
| Cover glass | ∞ | 1.0 | BK7 | 10.0 × 10.0 |
| | ∞ | 0 | | 10.0 × 10.0 |
| Slide | ∞ | 0.15 | Photo film | 8.325 × 6.25 |
| | ∞ | 0 | | 8.325 × 6.25 |
| Prism | ∞ | 20.0 | BK7 | 10.0 × 10.0 |
| | ∞ | | | 10.0 × 10.0 |
| Entrance pupil | ∞ | 11.6 | | 5.2 |

TABLE 2

| ## | R | T | material | CA |
|---|---|---|---|---|
| CCD | ∞ | 4.0 | | 4.9 × 3.8 |
| Camera | ∞ | 1.0 | BK7 | — |
| glass | ∞ | 10.0 | | — |
| 1 | −3.062 | 1.0 | ACRYLIC | 2.16 |
| 2 | −5.776 | 1.5 | | 2.62 |
| 3 | −3.360 | 1.2 | POLYSTYRENE | 3.72 |
| 4 | −2.533 | 160.0 | | 4.32 |

TABLE 3

| ## | k | D | E | F | G |
|---|---|---|---|---|---|
| 1 | −4.6628 | 0.01774 | −0.003378 | 0.0025 | −0.000656 |
| 2 | 0 | 0.0427 | −0.00153 | 0.001592 | 0.000124 |
| 3 | 0 | 0.0051 | −0.002019 | 0.000136 | 2.64628E−05 |
| 4 | 0.1215 | 0.0021 | −0.000231 | −5.1158E−06 | 4.95137E−06 |

TABLE 4

| ## | R | T | material | CA |
|---|---|---|---|---|
| slide | ∞ | 0.15 | photo film | 8.325 × 6.25 |
| prism | ∞ | 20.0 | BK7 | — |
| prism | ∞ | 2.0 | | |
| 1 | −29.302 | 2.0 | SF6 | 6.7 |
| 2 | −13.436 | 3.29 | | 6.6 |
| 3 | 152.817 | 1.3 | ACRYLIC | 4.8 |
| 4 | 6.785 | 3.0 | | 5 |
| 5 | −55.126 | 5.62 | SF6 | 7.85 |
| 6 | −10.403 | 120.0 | | 10.6 |

TABLE 5

| ## | k | D | E | F | G | H |
|---|---|---|---|---|---|---|
| 3 | 0 | −0.00482 | 0.00029 | −1.3014e−05 | −2.099e−6 | −2.7508e−7 |
| 4 | 0 | −0.00422 | 4.87E−05 | 2.187e−05 | −1.5854e−6 | −1.1837e−8 |

1. A method for determining a three-dimensional configuration for a portion of an object comprising:
(A) sequentially illuminating said portion with a series of light patterns, said series comprising N different light patterns, where N is an odd number greater than or equal to three;
(B) detecting light reflected from said portion for each of the N different light patterns; and
(C) determining said three-dimensional configuration using said detected light for the N different light patterns;
wherein the N different light patterns are characterized by:
(i) a common pattern which is periodic and is phase-shifted among the different patterns by 1/N of a period; and
(ii) a substantially identical spectral content at said portion of said object;
and wherein in step (A), the series of light patterns is produced using N slides, each slide having a periodic transmission function and being separately illuminated to produce one of the N different light patterns.

2. The method of claim 1 wherein a separate light source is associated with each of the N slides and is separately activated to produce one of the N different light patterns.

3. The method of claim 2 wherein each of the light sources is a light emitting diode.

4. A method for determining a three-dimensional configuration for a portion of an object comprising:
(A) sequentially illuminating said portion with a series of light patterns, said series comprising N different light patterns, where N is an odd number greater than or equal to three;
(B) detecting light reflected from said portion for each of the N different light patterns; and
(C) determining said three-dimensional configuration using said detected light for the N different light patterns;
wherein the N different light patterns are characterized by:
(i) a common pattern which is periodic and is phase-shifted among the different patterns by 1/N of a period; and
(ii) a substantially identical spectral content at said portion of said object;
and wherein in step (A), the series of light patterns is produced using a light source and a slide which:
(a) has a periodic transmission function, and
(b) is moved to a series of positions to produce the series of light patterns using a piezoelectric device having a cycle time from rest through movement and back to rest which is less than or equal to 3 milliseconds.

5. A method for determining a three-dimensional configuration for a portion of an object comprising:
(A) sequentially illuminating said portion with a series of light patterns, said series comprising N different light patterns, where N is an odd number greater than or equal to three;
(B) detecting light reflected from said portion for each of the N different light patterns; and
(C) determining said three-dimensional configuration using said detected light for the N different light patterns;
wherein the N different light patterns are characterized by:
(i) a common pattern which is periodic and is phase-shifted among the different patterns by 1/N of a period; and
(ii) a substantially identical spectral content at said portion of said object;
and wherein in step (A), the series of light patterns is produced using a light source and a transmissive pixelized panel which modulates light from the light source to produce the series of light patterns.

6. The method of claim 5 wherein the transmissive pixelized panel produces an additional light pattern which serves as a pointer for said portion of said object.

7. The method of claim 1 wherein in step (B), the light reflected from said portion of said object is transmitted to a light sensor using a fiber bundle.

8. The method of claim 7 wherein the light sensor comprises a charged coupled device.

9. The method of claim 1 wherein said substantially identical spectral content is composed of wavelengths from throughout the visible spectrum.

10. The method of claim 1 wherein said substantially identical spectral content is composed primarily of wavelengths from a selected band of the visible spectrum.

11. The method of claim 1 wherein said substantially identical spectral content is composed primarily of wavelengths from the near infrared band of the spectrum.

12. The method of claim 1 wherein the substantially identical spectral content is composed primarily of wavelengths from a selected band of the visible spectrum and said method further comprises filtering ambient illumination to reduce the ambient light intensity within the selected band at said portion of said object.

13. The method of claim 12 wherein:
(a) the light reflected from said portion of said object is detected using a sensor; and
(b) the light reaching the sensor is filtered to reduce the intensity of light outside the selected band.

14. The method of claim 1 wherein:
(a) the substantially identical spectral content is composed primarily of wavelengths from a selected band of the spectrum;
(b) the light reflected from said portion of said object is detected using a sensor; and
(c) the light reaching the sensor is filtered to reduce the intensity of light outside the selected band.

15. The method of claim 1 where N=3.

16. A method for determining a three-dimensional configuration for a portion of an object comprising:
(A) sequentially illuminating said portion with a series of light patterns;
(B) detecting light reflected from said portion for each of said light patterns; and
(C) determining said three-dimensional configuration using said detected light patterns;
wherein:
(i) said light patterns have a substantially identical spectral content which is composed primarily of wavelengths from a selected band of the spectrum; and
(ii) said method further comprises filtering ambient illumination to reduce the ambient light intensity within the selected band at said portion of said object.

17. The method of claim 16 wherein said filtering is performed using a sheet of filtering material which comprises a first region which transmits the selected band of the spectrum and a second region which substantially blocks the selected band.

18. The method of claim 17 wherein the object is a tooth and the sheet of filtering material is disposable.

19. The method of claim 16 wherein:
(a) the light reflected from said portion of said object is detected using a sensor; and
(b) the light reaching the sensor is filtered to reduce the intensity of light outside the selected band.

20. An optical system for use in illuminating a portion of an object with N light patterns comprising:
(A) N slides for generating the N light patterns;
(B) a projection lens having an entrance pupil; and
(C) an illumination system for separately passing light through each of the slides and into the projection lens' entrance pupil;
wherein:
(i) the N slides have a common transmission function which is periodic and is phase-shifted among the slides by 1/N of a period; and
(ii) the illumination system and the projection lens sequentially form real images of the N slides which have a substantially identical spectral content.

21. The optical system of claim 20 wherein:
(a) said illumination system comprises N light sources, one light source being associated with each of the N slides; and
(b) said light sources are separately activated to produce said N light patterns.

22. The optical system of claim 21 wherein the light sources are light emitting diodes.

23. The optical system of claim 20 wherein the illumination system comprises a prism assembly which separately receives light from each of the N slides and transmits at least a portion of said light to the entrance pupil of the projection lens.

24. The optical system of claim 23 wherein:
(a) the prism assembly receives substantially the same light intensity from each of the N slides; and
(b) the prism assembly transmits substantially the same portion of the received light to the projection lens' entrance pupil for each of the N slides.

25. Apparatus for use in determining a three-dimensional configuration for a portion of an object comprising the optical system of claim 20 and a sensor for detecting light reflected from said portion of said object.

26. The apparatus of claim 25 further comprising a fiber bundle which transmits reflected light to the sensor.

27. The apparatus of claim 26 wherein the sensor comprises a charged coupled device.

28. The apparatus of claim 25 wherein the illumination system produces light having a spectral content which is composed primarily of wavelengths from a selected band of the spectrum and the apparatus further comprises a first filter for controlling the spectral content of ambient light impinging on said portion of said object and a second filter for controlling the spectral content of reflected light reaching said sensor wherein:
(i) the first filter at least partially blocks light from the selected band of the spectrum; and
(ii) the second filter substantially passes light from the selected band of the spectrum and at least partially blocks light from at least one other band of the spectrum.

29. An optical system for use in illuminating a portion of an object with first, second, and third light patterns comprising:
(A) first, second, and third slides for generating the first, second, and third light patterns, respectively;
(B) a projection lens for forming a real image of each slide, said projection lens having a short conjugate principal plane; and
(C) a prism assembly comprising a first face for receiving light from the first slide, a second face for receiving light from the second slide, a third face for receiving light from the third slide, and a fourth face for transmitting at least some of the light which has entered the prism assembly from the first, second, or third faces to the projection lens;
wherein the optical path length from each slide to the short conjugate principal plane of the projection lens is substantially the same.

30. An optical system for use in illuminating a portion of an object with first, second, and third light patterns comprising:
(A) first, second, and third slides for generating the first, second, and third light patterns, respectively;
(B) a projection lens for forming a real image of each slide; and
(C) a prism assembly comprising a first face for receiving light from the first slide, a second face for receiving light from the second slide, a third face for receiving light from the third slide, and a fourth face for transmitting at least some of the light which has entered the prism assembly from the first, second, or third faces to the projection lens;
wherein:
(i) the mean values of the transmission functions of the three slides are substantially equal; and
(ii) for equal illumination, the prism assembly transmits substantially the same amount of light to the projection lens from each of the slides.

31. The optical system of claim 30 wherein:
(a) the prism assembly comprises a plurality of subassemblies which define a plurality of diagonals which partially transmit and partially reflect incident light; and
(b) the transmission/reflection properties of at least one of said diagonals differs from the transmission/reflection properties of at least one other of said diagonals.

32. An optical system for use in illuminating a portion of an object with first, second, and third light patterns comprising:
(A) first, second, and third slides for generating the first, second, and third light patterns, respectively;
(B) a projection lens for forming a real image of each slide; and
(C) a prism assembly comprising a first face for receiving light from the first slide, a second face for receiving light from the second slide, a third face for receiving light from the third slide, and a fourth face for transmitting at least some of the light which has entered the prism assembly from the first, second, or third faces to the projection lens;
wherein the first, second, and third faces define first, second, and third planes, the first plane being orthogonal to each of the second and third planes and the second plane being orthogonal to the third plane.

33. The optical system of claim 32 wherein:
(a) first, second, and third light sources are associated with the first, second, and third slides, respectively;
(b) the optical path from the first light source to the first slide is straight;
(c) the optical path from the second light source to the second slide is straight; and
(d) the optical path from the third light source to the third slide is folded.

34. The optical system of claim 33 where a prism folds the optical path from the third light source to the third slide.

35. An optical system for use in illuminating a portion of an object with first, second, and third light patterns comprising:
(A) first, second, and third slides for generating the first, second, and third light patterns, respectively;
(B) a projection lens for forming a real image of each slide; and
(C) a prism assembly comprising a first face for receiving light from the first slide, a second face for receiving light from the second slide, a third face for receiving light from the third slide, and a fourth face for transmitting at least some of the light which has entered the prism assembly from the first, second, or third faces to the projection lens;
wherein:
(i) the optical system further comprises a light source which can be selectively activated;
(ii) the prism assembly comprises a fifth face for receiving light from the light source; and
(iii) the fourth face transmits at least some of the light which has entered the prism assembly through the fifth face to the projection lens.

36. Apparatus for use in determining a three-dimensional configuration for a portion of an object comprising:
(A) an optical system for illuminating said portion of said object with a plurality of light patterns;
(B) a sensor assembly for detecting light reflected from said portion, said assembly comprising first and second sensors; and
(C) a fiber bundle for transmitting reflected light to said sensor assembly;
wherein the sensor assembly comprises a router for providing reflected light to the first and second sensors.

37. The apparatus of claim 36 wherein the router comprises a stationary mirror which transmits substantially equal portions of the reflected light to the first and second sensors.

38. The apparatus of claim 36 wherein the router comprises a movable mirror for selectively providing reflected light to the first and second sensors.

39. The apparatus of claim 36 where the first sensor is a black and white charged coupled device and the second sensor is a color charged coupled device.

40. Apparatus for use in determining a three-dimensional configuration for a portion of an object comprising:
(A) an optical system for illuminating said portion of said object with a plurality of light patterns, said light patterns being composed primarily of wavelengths from a selected band of the spectrum; and
(B) a sheet of filtering material which comprises a first region which transmits the selected band of the spectrum and a second region which substantially blocks the selected band.

41. The apparatus of claim 40 wherein the selected band of the spectrum is the red band.
